(19) United States
(12) Patent Application Publication
(10) Pub. No.: US 2011/0320055 A1
(43) Pub. Date: Dec. 29, 2011

(54) ELECTRONIC APPARATUS

(75) Inventor: Yoshiyuki YAMACHI, Kawasaki (JP)

(73) Assignee: FUJITSU LIMITED, Kawasaki (JP)

(21) Appl. No.: 13/230,366

(22) Filed: Sep. 12, 2011

Related U.S. Application Data
(63) Continuation of application No. PCT/JP2009/055532, filed on Mar. 19, 2009.

(51) Int. Cl. G05D 23/00; G05D 7/00

(52) U.S. Cl. 700/291

(57) ABSTRACT

An electronic apparatus includes a power measurement unit that measures a consumed power value, which is a value of power consumed by a cooling target, a power measurement value storage unit that stores a history of the consumed power value measured by the power measurement unit, a power prediction unit that predicts a power value to be consumed by the cooling target using the history of the consumed power value stored by the power measurement value storage unit, and a cooling control unit that controls a cooling unit so as to change a cooling strength on the cooling target according to the power value predicted by the power prediction unit.

### CROSS-REFERENCE TO RELATED APPLICATION

This application is a continuation of International Application No. PCT/JP2009/055532, filed on Mar. 19, 2009, the entire contents of which are incorporated herein by reference.

### FIELD

The embodiments discussed herein are directed to an electronic apparatus, and non-transitory computer-readable storage medium.

### BACKGROUND

Conventionally, an electronic apparatus includes a cooling device for cooling electronic components to prevent the own apparatus from being degraded by heat generated by the electronic components in the electronic apparatus. Such cooling device may be a cooling fan or a radiator.

In recent years, a cooling control device for controlling the cooling device to cool the heat of the electronic components while suppressing power used to drive the cooling device for environmental ecology countermeasures is known. For instance, the cooling control device changes the cooling strength on the cooling target according to the state of the electronic apparatus.

A technique of changing the cooling strength according to the current amount supplied to an electronic device is known as an example of the cooling control device for changing the cooling strength according to the state of the electronic apparatus (see e.g., Japanese Laid-open Patent Publication No. 06-274250). In such cooling control device, the current amount supplied to the electronic device to be cooled is measured, and the number of cooling fans to drive is changed according to the measured current amount to cool the electronic device.

The cooling control device for changing the cooling strength according to the current amount will be specifically described with reference to FIG. 15. FIG. 15 is a block diagram for explaining the conventional art. As illustrated in the figure, the cooling control device includes a cooling strength information table in which the cooling strength information indicating the strength of cooling the component and the current amount are stored corresponding to each other. The cooling control device measures the current amount that flows to the monitoring target with a current sensor based on such configuration.

The cooling control device acquires the cooling strength information corresponding to the measured current amount from the cooling strength information table. The cooling control device then performs a control to change the strength of the cooling fan according to the acquired cooling strength information, and cools the cooling target.

A technique of monitoring the temperature of the electronic device and controlling the strength at which the cooling fan cools the electronic device etc. is known as an example of the cooling fan for changing the cooling strength according to the state of the electronic apparatus (see e.g., Japanese Laid-open Patent Publication No. 09-305268).

In the technique of changing the cooling strength according to the current amount or the temperature, however, the cooling strength is changed according to the current amount or the temperature at the measured time point, and hence the cooling strength is increased when the temperature of the cooling target rises so as to follow such rise. The cooling target thus may not be appropriately cooled.

That is, since the temperature of the cooling target once becomes high temperature when the temperature of the cooling target rises, the cooling target may degrade and the cooling may be performed at a high cooling strength to cool the raised temperature and hence the power supplied to the cooling device may become high. As a result, the cooling target may not be appropriately cooled.

### SUMMARY

According to an aspect of an embodiment of the invention, an electronic apparatus includes a power measurement unit that measures a consumed power value, which is a value of power consumed by a cooling target, a power measurement value storage unit that stores a history of the consumed power value measured by the power measurement unit, a power prediction unit that predicts a power value to be consumed by the cooling target using the history of the consumed power value stored by the power measurement value storage unit, and a cooling control unit that controls a cooling unit so as to change a cooling strength on the cooling target according to the power value predicted by the power prediction unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram illustrating a computer apparatus according to a first embodiment;

FIG. 2 is a view illustrating a history of power measurement values according to the first embodiment;

FIG. 3 is a view illustrating a specific heat table of an electronic component;

FIG. 4 is a view illustrating a cooling strength information table;

FIG. 5 is a view (1) for explaining a consumed power prediction method according to the first embodiment;

FIG. 6 is a view (2) for explaining the consumed power prediction method according to the first embodiment;

FIG. 7 is a view (1) illustrating the consumed power measurement result of a processor and the predicted consumed power according to the first embodiment;

FIG. 8 is a view (2) illustrating the consumed power measurement result of the processor and the predicted consumed power according to the first embodiment;

FIG. 9 is a view illustrating the predicted temperature of the processor and the corresponding number of rotations of the cooling fan according to the first embodiment;

FIG. 10 is a flowchart of a cooling process performed by the computer apparatus according to the first embodiment;

FIG. 11A is a block diagram illustrating an electronic apparatus according to a second embodiment;

FIG. 11B is a view for explaining a cooling process according to a third embodiment;

FIG. 12 is a view of a computer which executes a prediction cooling program;

FIG. 13 is a conceptual view (1) for explaining the difference with the conventional art;

FIG. 14 is a conceptual view (2) for explaining the difference with the conventional art; and

FIG. 15 is a block diagram for explaining the conventional art.

### DESCRIPTION OF EMBODIMENTS

Embodiments of the present invention will be explained with reference to accompanying drawings.

### [a] First Embodiment

In the following examples, the configuration of the computer apparatus including the cooling device and the flow of processes will be described in order.

Configuration of Computer Apparatus

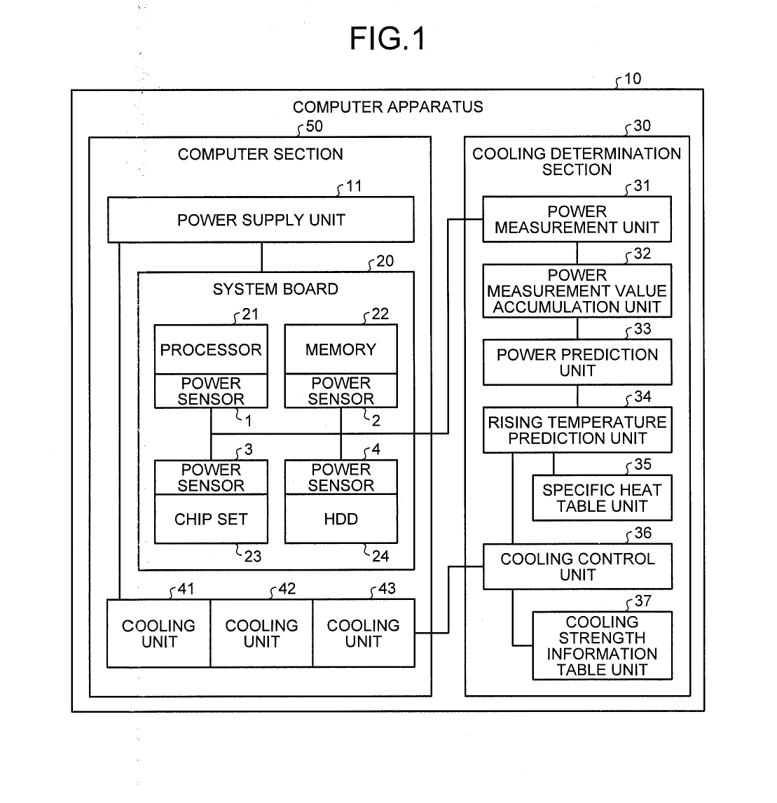

First, the configuration of the cooling device according to a first embodiment will be described with reference to FIGS. 1 to 10. FIG. 1 is a block diagram illustrating the computer apparatus according to the first embodiment. As illustrated in FIG. 1, a computer apparatus 10 includes a computer section 50 and a cooling determination section 30, and the computer section 50 and the cooling determination section 30 are connected to each other through a bus or the like.

The computer section 50 includes a power supply unit 11, a system board 20, and cooling units 41 to 43. The system board 20 is mounted with a processor 21, a memory 22, a chip set 23, a Hard Disk Drive (HDD) 24, and power sensors 1 to 4.

The power supply unit 11 supplies electricity to each section of the computer apparatus 10, the processor 21, the memory 22, the chip set 23, and the HDD 24 in the example of FIG. 1. The processor 21 transfers and processes data, controls a program, and the like in the computer apparatus 10. The memory 22 stores various types of information in the computer apparatus 10.

The chip set 23 is an integrated circuit in which a plurality of integrated circuits is combined. The HDD 24 stores information in the computer apparatus 10. The processor 21, the memory 22, the chip set 23, and the HDD 24 are examples of electronic components for achieving the function of the computer section 50, and operate with the power supplied from the power supply unit 11. The power sensors 1 to 4 are power sensors given to each electronic component 21 to 24, and are provided to monitor the power consumed by each electronic component 21 to 24 to which they are respectively attached.

The cooling units 41 to 43 cool the electronic components 21 to 24 of the computer apparatus 10. Specifically, each cooling unit 41 to 43 is controlled by a cooling control unit 36, and respectively cools different electronic components. In FIG. 1, for example, the cooling unit 41 cools the processor 21, the cooling unit 42 cools the memory 22 and the chip set 23, and the cooling unit 43 cools the HDD 24.

The cooling units 41 to 43 merely need to be able to cool each electronic component 21 to 24 or the entire computer apparatus 10, and may be a cooling fan, a water-cooling device, a radiator, a peltier element, or an arbitrary combination thereof. In the description below, a case of using the cooling fan as an example of the cooling unit will be described.

The cooling determination section 30 includes a power measurement unit 31, a power measurement value accumulation unit 32, a power prediction unit 33, a rising temperature prediction unit 34, a specific heat table unit 35, the cooling control unit 36, and a cooling strength information table unit 37. The cooling determination section 30 is independent from the computer section 50, and is applied to an independent management unit called a Service Processor (SVP) or a Management Board (MMB).

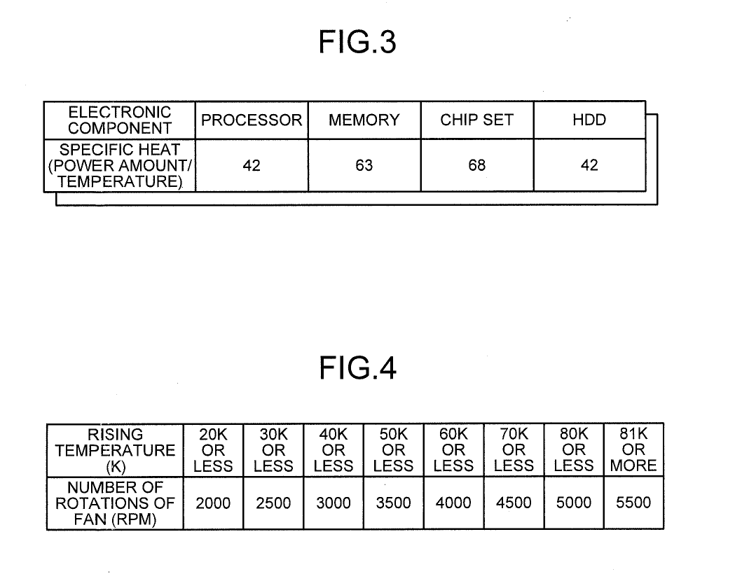

The specific heat table unit 35 stores specific heat indicating the relationship of the temperature to which the cooling target rises and the power amount for raising the temperature of the cooling target. FIG. 3 is a view illustrating a specific heat table of the electronic component. As illustrated in FIG. 3, the specific heat table unit 35 stores the specific heat representing the power amount to raise the temperature of each electronic component 21 to 24 by one degree (1 K) in absolute temperature. In FIG. 3, the specific heat of the processor is “42”.

FIG. 4 is a view illustrating a cooling strength information table. As illustrated in FIG. 4, the cooling strength information table unit 37 stores the rising temperature and the cooling strength information indicating the strength of cooling the cooling target corresponding to each other. The cooling strength information is information representing the strength of cooling the cooling target. In the example of FIG. 4, the cooling strength information table unit 37 stores number of rotations of the cooling fan for the cooling strength information.

The power measurement unit 31 acquires the power to be consumed by each electronic component 21 to 24 from the power sensors 1 to 4 corresponding to each electronic component 21 to 24, and measures the consumed power of the respective electronic components 21 to 24. The power measurement unit 31 does not measure current but measures power since the electronic components 21 to 24 might self-change the operation voltage.

The power measurement value accumulation unit 32 stores the consumed power value of each electronic component 21 to 24 measured by the power measurement unit 31 at a predetermined time interval.

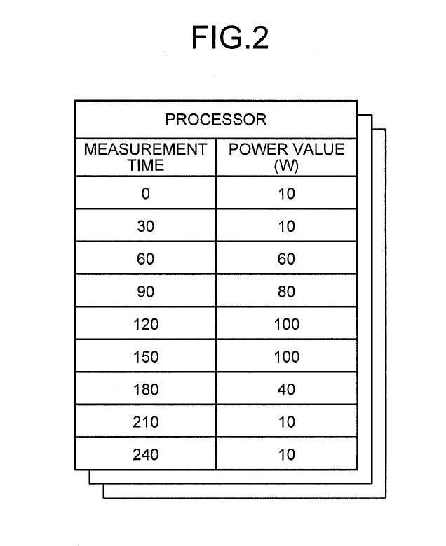

The process performed by the power measurement value accumulation unit 32 will now be described with reference to FIG. 2. FIG. 2 illustrates a history of power measurement values according to the first embodiment. As illustrated in FIG. 2, the power measurement value accumulation unit 32 stores the consumed power value of each electronic component 21 to 24 measured by the power measurement unit 31 corresponding to the measurement time. In the example of FIG. 2, the power measurement value related to the processor is illustrated. The measurement time represents the time elapsed from when the power measurement unit 31 starts to measure the power consumed by each electronic component 21 to 24. The following description will be made assuming the interval at which the power measurement unit 31 measures the power values of the electronic components 21 to 24 or the cooling target is 30 seconds.

The power prediction unit 33 predicts the value of the power to be consumed by each electronic component 21 to 24 until a constant time has elapsed from an arbitrary time point based on the history of consumed power values stored in the power measurement value accumulation unit 32. The power prediction unit 33 calculates an equation representing a nonlinear curve for interpolating each power value using the history of consumed power values of each electronic component stored by the power measurement value accumulation unit 32 when predicting the value of the power to be consumed by each electronic component 21 to 24 in the future. The power prediction unit 33 predicts the value of the power to be consumed by the cooling target until a constant time has elapsed based on the derived equation.

The process of predicting the value of the consumed power will be more specifically described. The power prediction unit 33 derives the equation representing a nonlinear curve using the most recent three points of the consumed power values of the history of power values stored in the power measurement value accumulation unit 32. The power prediction unit 33 calculates the power value between the most recent two points of the consumed power values using the derived equation, and predicts the value of the power to be consumed by each electronic component 21 to 24 until a constant time has elapsed from the most recent consumed power value measurement time point using the difference between the measured power value and the most recent power value.

The reason for deriving the equation representing the nonlinear curve for interpolating the most recent three points of the consumed power values using the history of power values will be described below. The consumed power value measured by the power measurement unit 31 is a discrete numerical value since the power measurement unit 31 performs the measurement at a constant interval. The derived nonlinear curve approximates the transition of the power value in the range the power measurement unit 31 does not perform the measurement with continuous values. As a result, the power prediction unit 33 can predict a more appropriate consumed power if the prediction is performed using the continuous values drawn by the nonlinear curve than when the prediction is performed using the discrete numerical values. The power prediction unit 33 thus derives the equation representing the nonlinear curve for interpolating the most recent three points of the consumed power values using the history of power values.

For instance, if the power prediction unit 33 approximates the consumed power values at the time point of the measurement times of 0 second, 30 seconds, and 60 seconds with the nonlinear curve, the power prediction unit 33 can obtain the transition of the power value approximated with the nonlinear curve from the measurement times of 0 second to 60 seconds. Thus, the power prediction unit 33 can perform a prediction of higher accuracy.

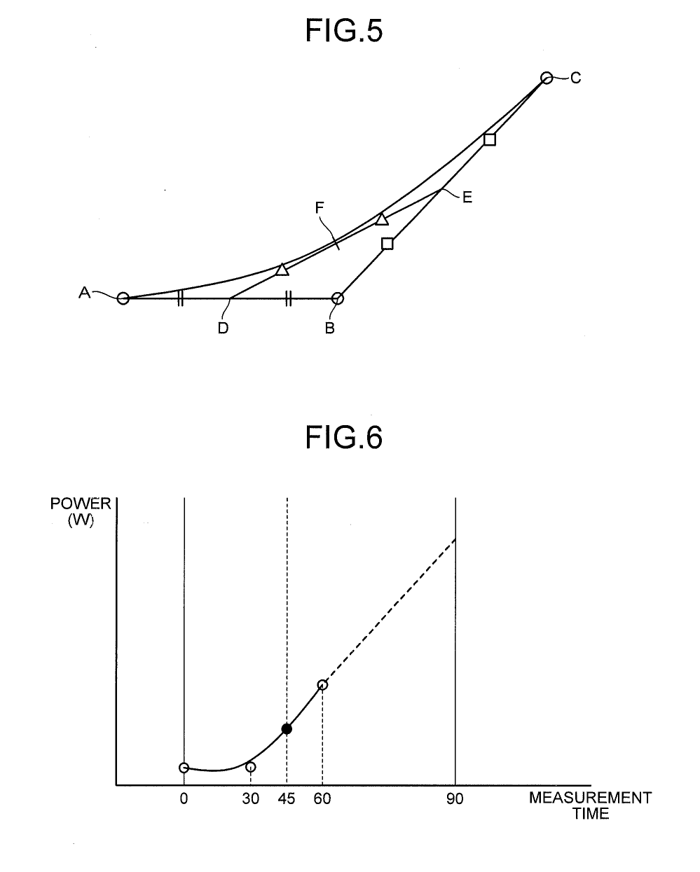

A case in which a B-spline curve is used will be described as an example of the nonlinear curve used to obtain the transition of the consumed power value of each electronic component 21 to 24 with reference to FIG. 5. FIG. 5 is a view for explaining a consumed power prediction method according to the first embodiment. The power prediction unit 33 interpolates the stored consumed power value using the equation representing the B-spline curve. For instance, the simplest B-spline curve can draw a curve connecting two points at both ends using three points existing in a plane.

A case of connecting point A and point C with the B-spline curve in FIG. 5 will be described. Point B is a point between point A and point C, and is a point that controls the bending degree of the curve. Point D is a point that equally divides a line AB. Point E is a point that equally divides a line BC. Point F is a point that equally divides a line DE. The B-spline curve that connects point A and point C becomes a curve having the line DE as a tangent line at point F.

The power prediction unit 33 according to the first embodiment calculates the equation representing the B-spline curve having time on a horizontal axis and power on a vertical axis using the most recent three points of the history of consumed power values stored in the power measurement value accumulation unit 32. Point A, point B, and point C illustrated in FIG. 5 respectively correspond to the measurement time of three points. As a result, the power prediction unit 33 can obtain a continuous curve that approximates a smooth transition of the power values.

The power prediction unit 33 calculates the approximated consumed power value of 15-second interval using the equation representing the B-spline curve obtained by the calculation using the consumed power values of three points. The power prediction unit 33 predicts the future consumed power using an increased amount of the most recent two consumed power values of the consumed power values obtained at a 15-second interval including the approximated consumed power value. Thus, the interval of the consumed power value used for prediction becomes shorter than the measurement interval of the actual measurement, so that the prediction calculation of higher accuracy can be performed. As a result, a more appropriate cooling can be performed in advance.

The method of predicting the power to be consumed in the future by each electronic component 21 to 24 using the transition of the consumed power value obtained from the B-spline curve will now be described with reference to FIG. 6. FIG. 6 is a view for explaining the consumed power prediction method according to the first embodiment. In the example of FIG. 6, the history of consumed power values of the processor 21 at the time point of measurement times of 0 second, 30 seconds, and 60 seconds is displayed with a white circle with the measurement time on the horizontal axis and the power value on the vertical axis.

The power prediction unit 33 calculates the equation representing the B-spline curve using the three power values stored in the power measurement value accumulation unit 32. For instance, the power prediction unit 33 calculates the equation representing the B-spline curve using the history of consumed power values measured at the time point of measurement times of 0 second, 30 seconds, and 60 seconds at the time point the measurement time is 60 seconds. Furthermore, the power prediction unit 33 predicts the consumed power at the time point of measurement time of 90 seconds, that is, the time point 30 seconds have further elapsed from the time point of most recent measurement time of 60 seconds with the B-spline curve represented by the calculated equation as a continuous curve which expresses the transition of the power consumed by the processor 21.

Specific calculation examples will be described below. First, the secondary B-spline curve used by the power prediction unit 33 can be represented with the following formula assuming the horizontal axis x is the measurement time and the vertical axis y is the power value.

x=x₀(1−t)²+2x₁t(1−t)+x₂t² (1)

y=y₀(1−t)²+2y₁t(1−t)+y₂t² (2)

Here, x₀, x₁, x₂ represent the measurement time. Furthermore, y₀, y₁, y₂ represent the consumed power measured at the time of the measurement time x₀, x₁, x₂. t is a parameter and takes a value of equal to or more than 0 and smaller than or equal to 1.

In the case of FIG. 6, the consumed power of the processor 21 at the time point of the measurement times of 0 second, 30 seconds, and 60 seconds is 10 (W), 10 (W), and 60 (W), respectively. The approximate value of the consumed power at the midpoint of the measurement time of 30 seconds and the measurement time of 60 seconds, that is 45-second time point or the time point 15 seconds have elapsed from the measurement time of 30 seconds is obtained using equations (1) and (2). The value of the parameter t at the time point of x=45 seconds obtains the value of t=0.75 from equation (1). The value of the parameter y at the time point of x=45 seconds becomes y=38.125 from equation (2).

As a result, the consumed power approximated at the measurement time of 45 seconds becomes 38.125 (W). In FIG. 6, the approximate consumed power value at the time point of the measurement time of 45 seconds is illustrated with a black circle. Furthermore, the power consumed by the processor 21 at the time point of the measurement time of 60 seconds is 60 (W). The power prediction unit 33 calculates the predicted consumed power of the processor 21 at the time point of the measurement time of 90 seconds using the amount of increase of the consumed power between the measurement times, 45 seconds and 60 seconds. In the case of FIG. 6, the first derivation curve of the measurement times of 45 seconds and 60 seconds is illustrated with a broken line. The value the broken line indicates at the time point of the measurement time of 90 seconds can be expressed with the following equation.

$$( \frac{60 - 38.125}{60 - 45} ) \times 30 + 60 = 103.75 \qquad ( 3 )$$

In the above example, the power prediction unit 33 predicts the power consumed by the processor 21 at the time point of the measurement time of 90 seconds is 103.75 (W).

The rising temperature prediction unit 34 uses the predicted power value of each electronic component 21 to 24 predicted by the power prediction unit 33 to calculate the power amount to be consumed by each electronic component 21 to 24 until a constant time has elapsed. The rising temperature prediction unit 34 uses the calculated predicted power amount to predict the temperature to which each electronic component 21 to 24 rises until a constant time has elapsed. Upon predicting the rising temperature, the specific heat of each electronic component 21 to 24 is acquired from the specific heat table unit 35, and the value obtained by dividing the calculated power amount with the specific heat is assumed as the predicted rising temperature or the temperature to which each electronic component 21 to 24 is assumed to rise until a constant time has elapsed.

The calculation of the power amount will be specifically described. The power amount indicates the amount represented by the product of the consumed power and the time in which the power is consumed. The rising temperature prediction unit 34 calculates the product of the predicted power and T as the power amount consumed by the electronic component when the power prediction unit 33 predicts the power consumed by the electronic component after T seconds.

In the case of the first embodiment, the power prediction unit 33 predicts the power consumed after 30 seconds from the most recent consumed power actual measurement time point. Thus, if the power the processor 21 consumes after 30 seconds is predicted as 103.75 (W), the rising temperature prediction unit 34 calculates the power amount obtained by the processor 21 until 30 seconds have elapsed with the following equation.

103.75 (w)×30 (sec)=3112.5 (J) (4)

The rising temperature prediction unit 34 predicts the power amount obtained by the processor 21 until 30 seconds have elapsed as 3112.5 (J).

The process of predicting the predicted rising temperature of each electronic component will now be described using the power amount predicted by the rising temperature prediction unit 34. The predicted rising temperature of each electronic component 21 to 24 becomes a value obtained by dividing the power amount obtained by each electronic component 21 to 24 by the specific heat of each electronic component 21 to 24. The rising temperature prediction unit 34 assumes the value obtained by dividing the predicted power amount by the specific heat of each electronic component stored in the specific heat table unit 35 as the predicted rising temperature of each electronic component.

For instance, in the case of the processor 21, the rising temperature prediction unit 34 obtains the value “42 (J/K)” of the specific heat of the processor 21 from the specific heat table unit 35 (see FIG. 3). The power amount obtained by the processor 21 is to be divided with the specific heat in order to obtain the predicted rising temperature of the processor 21. The predicted rising temperature of the processor 21 can be represented with the following equation.

3112.5 (J)/42 (J/K)=74.7 (K) (5)

As a result of the calculation of equation (5), the rising temperature prediction unit 34 predicts the predicted rising temperature of the processor 21 after 30 seconds as 74.7 (K).

The cooling control unit 36 acquires the cooling strength information corresponding to the rising temperature predicted by the rising temperature prediction unit 34 from the cooling strength information table unit 37, and controls the cooling units 41 to 43 to change the cooling strength on the cooling target based on the acquired cooling strength information. When controlling the cooling units 41 to 43, the cooling control unit 36 immediately drives the cooling units 41 to 43 based on the cooling strength information acquired from the cooling strength information table unit 37, and performs the cooling of the cooling target before the temperature of each electronic component 21 to 24 rises.

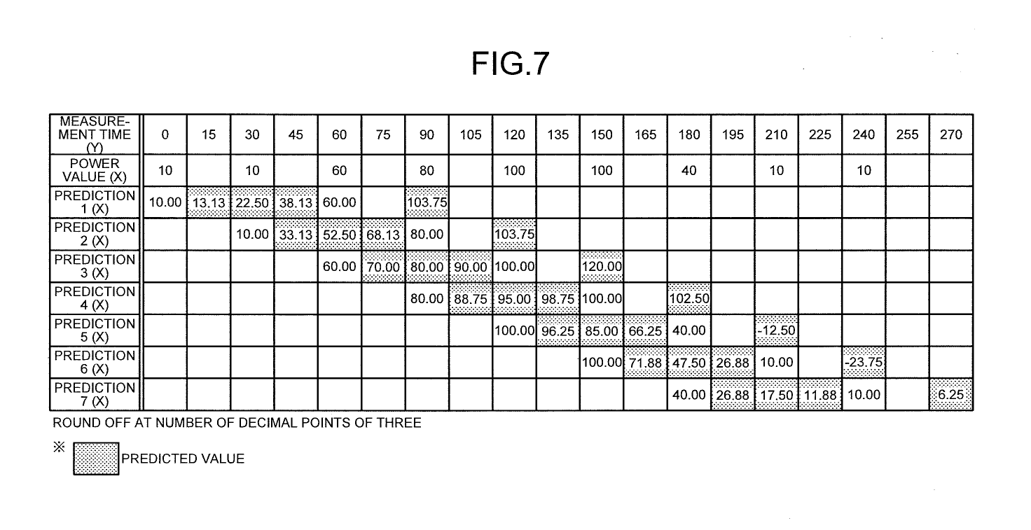

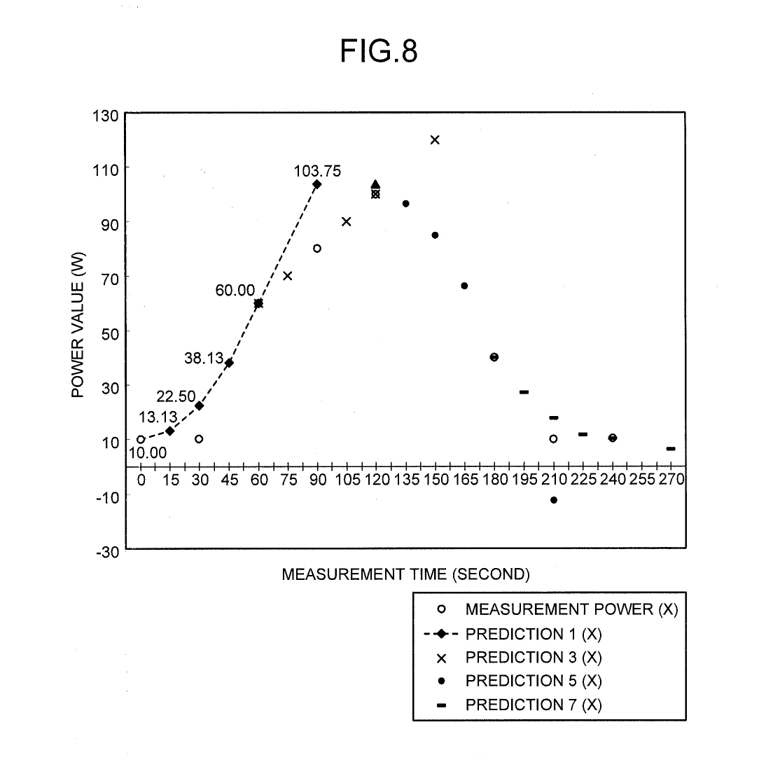

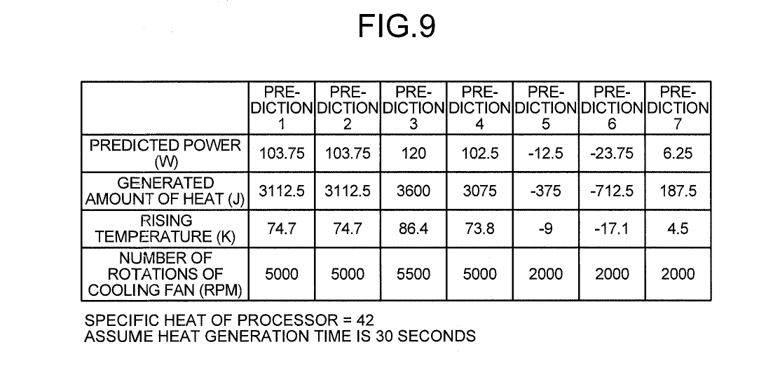

A cooling control process performed by the rising temperature prediction unit 34 and the cooling control unit 36 on the processor 21 will now be described with reference to the specific example illustrated in FIGS. 7 to 9. FIG. 7 is a view illustrating the consumed power calculation result of the processor 21 according to the first embodiment and the predicted consumed power. In the case illustrated in FIG. 7, in prediction 1, the values at the time point of when the measurement time is 0 second and 60 seconds are the actual measurement values, and the values of when the measurement time is 15 seconds, 30 seconds, and 45 seconds are the predicted consumed power. FIG. 8 is a view illustrating the consumed power calculation result of the processor 21 according to the first embodiment and the predicted consumed power. FIG. 9 is a view illustrating the predicted temperature of the processor 21 and the corresponding number of rotations of the cooling fan, according to the first embodiment.

The rising temperature prediction unit 34 acquires the predicted power value of the processor 21 from the power prediction unit 33. If the measurement time is 60 seconds, the rising temperature prediction unit 34 predicts the predicted power value obtained from the power prediction unit 33 after elapse of 30 seconds, that is, at the time point of 90 seconds as 103.75 (W) from equation (3). The rising temperature prediction unit 34 then predicts the power amount obtained in 30 seconds by the processor 21 using the predicted power value obtained from the power prediction unit 33. If the measurement time is 60 seconds, the rising temperature prediction unit 34 predicts the power amount of the processor 21 in 30 seconds, from the time point of the measurement time of 60 seconds to the time point of the measurement time of 90 seconds, as 3112.5 (J) from equation (4).

The rising temperature prediction unit 34 acquires the specific heat of the processor from the specific heat table unit 35. As illustrated in FIG. 4, the rising temperature prediction unit 34 acquires the value 42 (J/K) of the specific heat of the processor from the specific heat table unit 35. The rising temperature prediction unit 34 uses the predicted power amount and the acquired specific heat to calculate the rising temperature of the processor 21 at the time point of the measurement time of 90 seconds as 74.7 (K) through equation (5).

The cooling control unit 36 acquires the cooling strength information (number of rotations of cooling fan) corresponding to the predicted rising temperature of 74.7 (K) obtained for the processor 21 from the cooling strength information table unit 37, and drives the cooling unit 41 based on the acquired cooling strength information. In the example of FIG. 3, the cooling control unit 36 acquires the cooling strength information for driving the cooling fan at 5000 rotations per minute, which corresponds to the predicted rising temperature 74.7 (K). The cooling control unit 36 thus immediately drives the cooling unit 41 at 5000 rotations, and starts the cooling of the processor 21 before the temperature of the processor 21 actually rises.

The cooling control unit 36 cools the processor 21 at 2000 rotations, which is the minimum number of rotations illustrated in FIG. 4, if the predicted rising temperature obtained for the processor 21 is a negative value. If the predicted rising temperature is a negative value, this means that the temperature of the processor 21 lowers, and hence the cooling strength may be weakened.

As illustrated in FIG. 7, the power prediction unit 33 predicts the power value consumed by the processor 21 at the time point of the measurement time of 90 seconds based on the actual measurement values of the consumed power of the processor 21 at the time point the measurement time is 0 second, 30 seconds, and 60 seconds. Furthermore, the power prediction unit 33 calculates the predicted power value of the processor 21 at the time point of 120 seconds using the consumed power actual measurement values for each of the measurement times of 30 seconds, 60 seconds, and 90 seconds when the measurement time of 90 seconds has elapsed.

For instance, in the case of prediction 3 illustrated in FIG. 7, the power prediction unit 33 calculates the approximated power value for every 15 seconds that interpolate the period of the measurement times of 60 seconds, 90 seconds and 120 seconds, that is, the time point of 75 seconds and the time point of 105 seconds using the power values of such measurement times. The power prediction unit 33 calculates a nonlinear curve AC by corresponding the consumed power actual measurement value to point A, point B and point C illustrated in FIG. 5.

In the case of prediction 3 illustrated in FIG. 7, the nonlinear curve illustrated in FIG. 5 is obtained by corresponding the consumed power actual measurement value at the time point of the measurement time of 60 seconds to point A of FIG. 5, the consumed power actual measurement value at the time point the measurement time is 90 seconds to point B of FIG. 5, and the consumed power actual measurement value at the time point the measurement time is 120 seconds to point C of FIG. 5.

The power prediction unit 33 then calculates the consumed power value represented by the obtained nonlinear curve at the time point the measurement time is 75 seconds, 90 seconds, and 105 seconds as the approximated consumed power value. Furthermore, the power prediction unit 33 predicts the predicted power value of the processor 21 at the time point of the measurement time of 150 seconds as 120 (W) using the approximate power value of the measurement time of 105 seconds and the power value of the measurement time of 120 seconds.

The power value approximated by the power prediction unit 33 of the values illustrated in each prediction of FIG. 7 is displayed with a mesh. For instance, the approximated power value of the values shown in prediction 1 corresponds to the power values at the time point of the measurement times of 15 seconds, 30 seconds, and 45 seconds.

FIG. 7 displays the power value of the consumed power up to the measurement time of 240 seconds for the processor 21 and the predicted power value predicted by the power prediction unit 33 for every 30 seconds. FIG. 8 is a view in which the values illustrated in FIG. 7 are plotted as a graph. In the example of FIG. 8, the power prediction unit 33 predicts rise and fall of the power to be consumed by the processor 21, 30 seconds later.

FIG. 9 is a view summarizing the relationship of the predicted power value consumed by the processor 21, the predicted generating heat amount, the predicted rising temperature, and the number of rotations of the cooling fan corresponded to the predicted rising temperature. The rising temperature prediction unit 34 calculates the rising temperature of each electronic component 21 to 24 based on the power predicted by the power prediction unit 33 every 30 seconds. The cooling control unit 36 performs cooling based on the prediction after the calculation by the rising temperature prediction unit 34.

For instance, in the case of prediction 4, the rising temperature prediction unit 34 predicts the rising temperature of the processor 21 as 73.8 (K). The cooling control unit 36 thus controls the cooling unit so as to cool the processor 21 at 5000 rotations per minute, which is the number of rotations of the cooling fan corresponding to the predicted rising temperature “73.8”, immediately after the rising temperature of the processor 21 is predicted. In the case of prediction 5, the rising temperature prediction unit 34 predicts the rising temperature of the processor 21 as −9 (K). The cooling control unit 36 thus controls the cooling unit so as to cool the processor 21 at 2000 rotations per minute, which is the set minimum number of rotations of the cooling fan, immediately after the rising temperature is predicted.

Process of Computer Apparatus

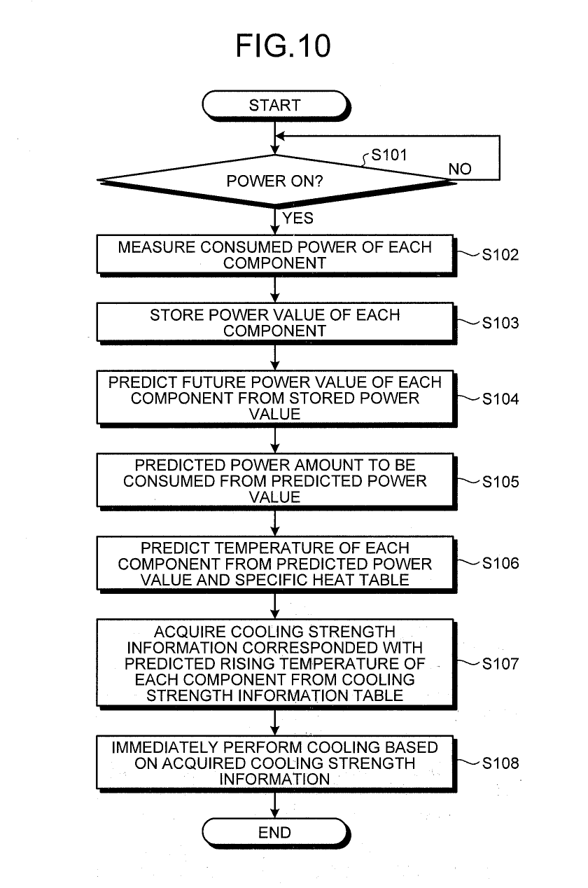

The flow of the cooling process performed by the computer apparatus 10 according to the first embodiment will now be described with reference to FIG. 10. FIG. 10 is a flowchart of the processes performed by the computer apparatus according to the first embodiment.

After the power of the computer apparatus 10 is turned ON (yes in step S101), the power measurement unit 31 measures the consumed power of each electronic component 21 to 24 every 30 seconds (step S102). The power measurement value accumulation unit 32 then stores the consumed power value measured in step S102 (step S103). The power prediction unit 33 predicts the predicted power value or the future consumed power value of each electronic component 21 to 24 using the consumed power value stored by the power measurement value accumulation unit 32 (step S104).

The rising temperature prediction unit 34 then predicts the future power amount using the predicted power value of each electronic component 21 to 24 predicted in step S104 (step S105). The rising temperature prediction unit 34 then uses the predicted power amount and the specific heat of the electronic component stored in the specific heat table unit 35 to predict the temperature to which each electronic component 21 to 24 rises until a constant time has elapsed (step S106).

The cooling control unit 36 acquires the cooling strength information corresponded to the predicted rising temperature of each electronic component 21 to 24 predicted by the rising temperature prediction unit 34 in step S106 from the cooling strength information table unit 37 (step S107).

Lastly, the cooling control unit 36 controls the cooling units 41 to 43 based on the cooling strength information acquired in step S107, and immediately cools each electronic component 21 to 24 (step S108) and terminates the series of processes.

As described above, the computer apparatus 10 according to the first embodiment measures the power consumed by each electronic component 21 to 24, sequentially stores the measured power values, and predicts the power value to be consumed by each electronic component 21 to 24 until a constant time has elapsed using the history of stored power values. The computer apparatus 10 also controls the cooling units 41 to 43 before elapse of a constant time according to the predicted power value, and starts the cooling of each electronic component 21 to 24 in a preventive manner before the temperature rises. Thus, the computer apparatus 10 can suppress the rising temperature of each electronic component 21 to 24 and an after heat compared to when cooling based on prediction is not performed.

As a result, the computer apparatus 10 can perform an appropriate cooling and can extend the lifespan of each electronic component 21 to 24. The computer apparatus 10 can also cool each electronic component 21 to 24 with small consumed power, and hence can perform an appropriate cooling.

Furthermore, if the power value predicted to be consumed in the future by each electronic component 21 to 24 becomes negative, the computer apparatus 10 weakens the strength of cooling beforehand so that noise can be reduced and the consumed power for cooling can be reduced. The computer apparatus 10 can perform an appropriate cooling as a result.

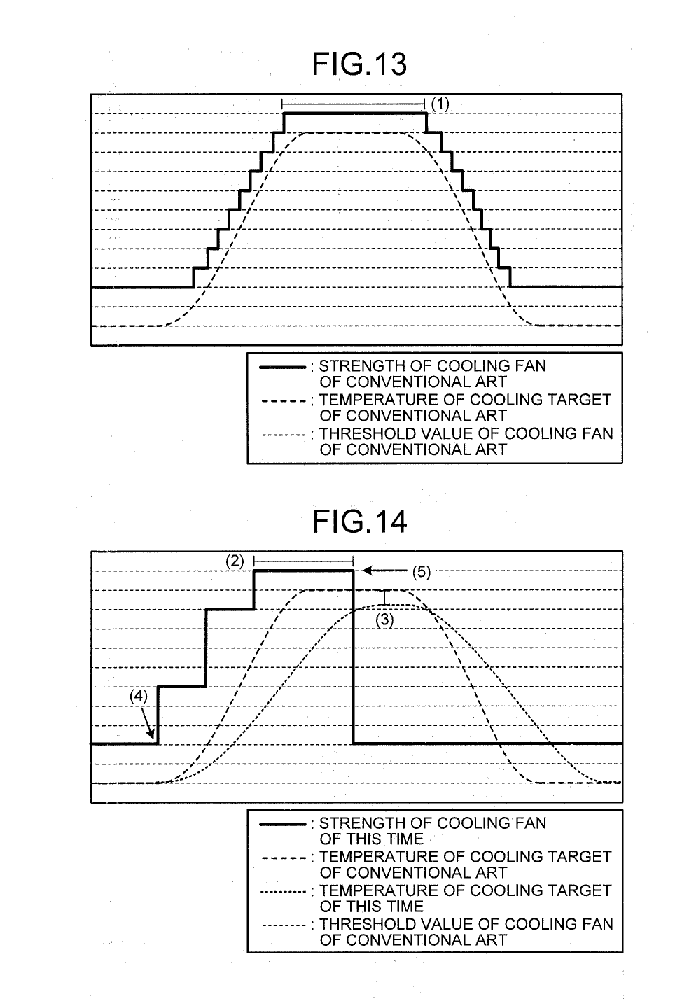

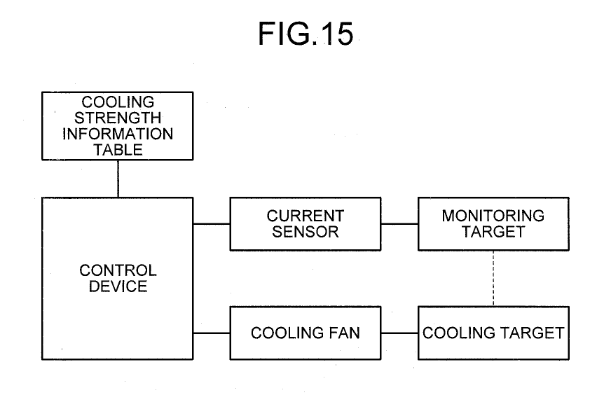

The effects of the computer apparatus 10 according to the first embodiment will be described with reference to FIGS. 13 and 14. FIG. 13 is a conceptual view (1) for explaining the cooling operation when the conventional art is applied. FIG. 14 is a conceptual view (2) for explaining the difference between the cooling operation according to the first embodiment and the conventional art.

In the technique of changing the strength of the cooling fan according to the temperature emitted by the cooling target, the temperature of the cooling target is actually rises, and the strength of the cooling fan is made stronger after the temperature of the cooling target exceeds a threshold value. When the temperature of the cooling target lowers, the strength of the cooling fan is not made weaker until the temperature becomes lower than the threshold value. The cooling fan is thus driven for a long time at the maximum strength as illustrated in (1) of FIG. 13.

In the first embodiment, the strength of the cooling fan is made stronger from before the temperature of the cooling target rises based on the predicted temperature rise of the cooling target, as illustrated in (4) of FIG. 14. Thus, the temperature of the cooling target does not become high temperature compared to when cooling is performed with the conventional method as illustrated in (3) of FIG. 14. Furthermore, if predicted that the temperature of the cooling target lowers, the strength of the cooling fan is immediately made weaker as illustrated in (5) of FIG. 14. Therefore, in the first embodiment, the time the cooling fan is driven at the maximum cooling strength becomes shorter compared to the example of FIG. 13, as illustrated in (2) of FIG. 14. As a result, the computer apparatus 10 according to the first embodiment can efficiently cool the cooling target.

The computer apparatus 10 derives the nonlinear curve using three points of the most recent consumed power values of each electronic component 21 to 24, predicts the consumed power value between the two points of the most recent power values using the nonlinear curve, and predicts the power value to be consumed by each electronic component 21 to 24 until a constant time has elapsed using the difference between the predicted consumed power value and the most recent consumed power value. Therefore, the computer apparatus 10 can perform cooling based on a more appropriate prediction in advance since prediction of higher accuracy can be made. As a result, the computer apparatus 10 can perform an appropriate cooling.

The computer apparatus 10 includes the specific heat table unit 35 that stores the specific heat which is the relationship of the rising temperature of each electronic component 21 to 24, and the power amount to raise the temperature of each electronic component 21 to 24. The computer apparatus 10 thus can perform cooling according to the rising temperature of each electronic component 21 to 24.

Since each electronic component 21 to 24 has different specific heat, the rising temperature differs for every electronic component even if the same power amount is consumed. However, the computer apparatus 10 can appropriately cool each electronic component 21 to 24 since the cooling corresponding to the rising temperature of each electronic component 21 to 24 can be performed in advance.

The computer apparatus 10 includes the cooling strength information table unit that stores the cooling strength information, which is information related to the strength of cooling each electronic component 21 to 24, and the rising temperature of each electronic component 21 to 24 corresponding to each other. The computer apparatus 10 thus can perform an appropriate cooling corresponding to the rising temperature. Furthermore, the computer apparatus 10 does not need to have the cooling strength information table unit 37 for each electronic component 21 to 24 since the computer apparatus 10 includes the specific heat table unit 35 and the cooling strength information table unit 37.

In other words, since the electronic components or the cooling targets have different specific heats, the rising temperature differs among the electronic components even if the same power amount is consumed. The computer apparatus 10 can predict the rising temperature for every cooling target as the computer apparatus 10 includes the specific heat table unit 35, and the cooling strength information corresponding to the predicted rising temperature can be used.

The computer apparatus 10 merely needs to store the specific heat of each cooling target in the specific heat table unit 35 even if the number of cooling targets is large, and the number of cooling strength information table unit 37 in which the rising temperature and the cooling strength are stored corresponding to each other is only one.

### [b] Second Embodiment

In the first embodiment, a case of predicting the power to be consumed in the future by each electronic component 21 to 24, and cooling each electronic component 21 to 24 based on the predicted result has been described. However, the present example is not limited thereto, and the power to be consumed by the entire computer apparatus may be observed, the power to be consumed in the future by the entire computer apparatus may be predicted, and the entire computer apparatus may be cooled based on the predicted result.

In the second embodiment, a case of calculating the predicted power value to be consumed in the future by a computer apparatus 10b using the power to be consumed by the entire computer apparatus 10b according to the second embodiment, and controlling the cooling unit for cooling the entire computer apparatus 10b using the calculated predicted power value will be described.

Configuration of Computer Apparatus

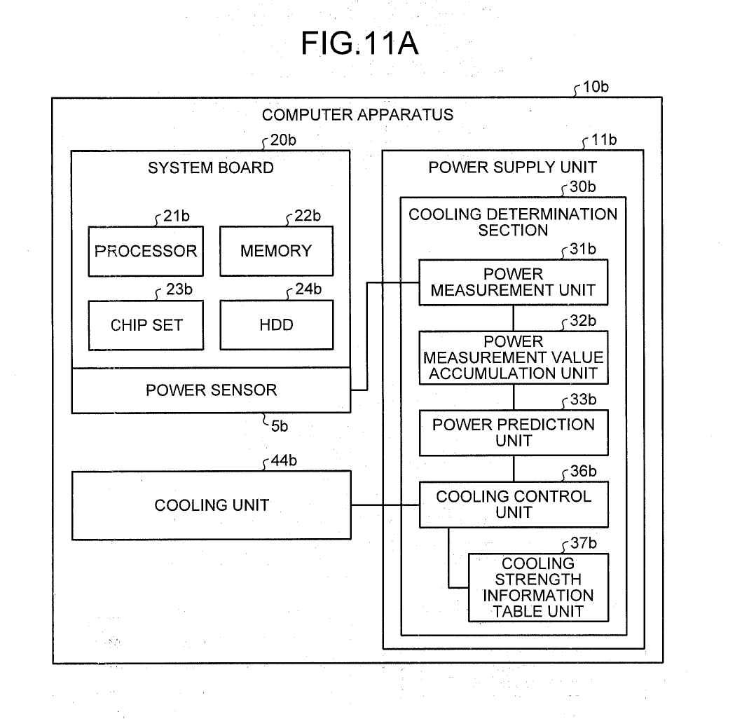

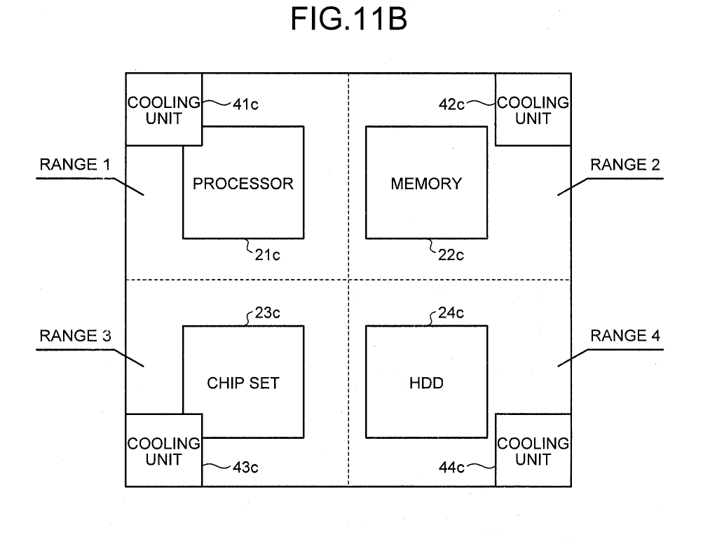

FIG. 11A is a block diagram for explaining the computer apparatus according to the second embodiment. A system board 20b according to the second embodiment includes a processor 21b, a memory 22b, a chip set 23b, and an HDD 24b, and is connected with a power sensor 5b for measuring the power to be consumed by the entire system board 20b.

In FIG. 11A, a cooling determination section 30b is incorporated in a power supply unit 11b. The cooling determination section 30b includes a power measurement unit 31b, a power measurement value accumulation unit 32b, a power prediction unit 33b, a cooling control unit 36b, and a cooling strength information table unit 37b. The power measurement unit 31b is connected to the power sensor 5b, and the cooling control unit 36b is connected to the cooling unit 44b.

The cooling unit 44b is controlled by the cooling control unit 36b, to be described later, and cools the entire computer apparatus 10.

The power measurement unit 31b uses the power sensor 5b installed on the system board 20b to measure the power consumed by the entire system for every constant time.

The power measurement value accumulation unit 32b stores the value of the consumed power of the entire system measured by the power measurement unit 31b.

The power prediction unit 33b acquires a plurality of histories of the power value of the entire system accumulated in the power measurement value accumulation unit 32b, and calculates the power to be consumed by the entire system of the computer apparatus 10b until a constant time has elapsed from an arbitrary time point as a predicted power value. Similar to the power prediction unit 33 of the first embodiment, the power prediction unit 33b interpolates the power value with the nonlinear curve, and then calculates and predicts the power to be consumed by the entire system until a constant time has elapsed.

Specifically, the cooling control unit 36b acquires the cooling strength information corresponded to the predicted power value from the cooling strength information table unit 37b according to the second embodiment based on the predicted power value predicted by the power prediction unit 33b, and controls and drives the cooling unit 44b using the acquired cooling strength information.

The cooling strength information table unit 37b according to the second embodiment saves the power consumed by the entire system of the computer apparatus 10b and the cooling strength information or the strength for cooling the computer apparatus 10b corresponding to each other.

The cooling control unit 36b acquires the cooling strength information corresponded to the predicted power value predicted by the power prediction unit 33b from the cooling strength information table unit 37b, and controls the cooling unit based on the acquired cooling strength information.

In the second embodiment, the power consumed by the entire electronic apparatus is measured and stored, the power to be consumed in the future by the entire electronic apparatus is predicted using the stored power value, and the cooling based on the predicted power value is performed in advance. The computer apparatus 10b thus can easily perform an appropriate cooling while reducing the number of power sensors.

### [c] Third Embodiment

In the present embodiment, the rising temperature of each electronic component 21 to 24 configuring the electronic apparatus is predicted, the distribution of the rising temperature of the entire electronic apparatus is presumed using the predicted rising temperature, and the cooling of the electronic apparatus is performed according to the distribution of the presumed rising temperature. The computer apparatus 10b according to the third embodiment predicts the power value to be consumed until a constant time has elapsed by each electronic component 21c to 24c according to the third embodiment, and predicts the predicted rising temperature of each electronic component 21c to 24c using the predicted power value. The computer apparatus 10b also presumes the distribution of the rising temperature of the computer apparatus 10b using the predicted rising temperature of each electronic component 21c to 24c, and cools the entire computer apparatus corresponding to the presumed temperature distribution.

The process in which the computer apparatus 10b presumes the distribution of the temperature to which the computer apparatus 10b rises using the predicted rising temperature of each electronic component 21c to 24c will now be described with reference to FIG. 11B. FIG. 11B is a view for explaining the cooling process according to the third embodiment. In FIG. 11B, the cooling determination section, the power supply unit, and the like included in the computer apparatus 10b are not illustrated. Ranges 1 to 4 illustrated in FIG. 11B are cooled by the cooling units 41c to 44c according to the third embodiment, respectively.

As heat spreads to the periphery, the actual rising temperature of memory 22c and chip set 23c in ranges 2 and 3 adjacent to a processor 21c becomes higher than the predicted rising temperature of memory 22c and chip set 23c if the predicted rising temperature of the processor 21c illustrated in FIG. 11B is high.

The computer apparatus 10b presumes the distribution of the rising temperature of the computer apparatus 10b using the predicted rising temperature of each electronic component 21c to 24c, and cools the entire computer apparatus corresponding to the presumed temperature distribution. For instance, if only the predicted rising temperature of the processor 21c is high temperature, the computer apparatus 10b makes the cooling strength of the cooling unit 41c stronger, makes the cooling strength of the cooling unit 42c and the cooling unit 43c to medium degree, and makes the cooling strength of the cooling unit 44c low.

The cooling control unit 36b presumes the distribution of the rising temperature of the entire computer apparatus based on the predicted rising temperature of each electronic component 21c to 24c, and presumes the rising temperature for every range cooled by each cooling unit 41c to 44c using the presumed distribution of the rising temperature. The cooling control unit 36b then acquires the cooling strength information corresponded to the rising temperature for every range from the cooling strength information table unit 37b, and immediately drives each cooling unit 41c to 44c with the acquired cooling strength information.

The computer apparatus 10b according to the third embodiment measures the power value consumed by each electronic component 21c to 24c, stores the measured power values, and predicts the power to be consumed by each electronic component 21c to 24c until a constant time has elapsed using the history of stored power values. The computer apparatus 10b also predicts the temperature to which each electronic component 21c to 24c rises until a constant time has elapsed using the predicted power, and presumes the distribution of the rising temperature of the entire computer apparatus 10b using the predicted rising temperature. The computer apparatus 10b then controls the cooling units 41c to 44c according to the presumed distribution of the rising temperature.

The computer apparatus 10b thus can perform an appropriate cooling since spread of heat generated by each electronic component can be taken into consideration.

### [d] Fourth Embodiment

Examples have been described up to now, but the example may be implemented in various different modes other than the examples described above. Other examples will be described below as a fourth embodiment.

(1) Cooling Method Performed by Cooling Unit

The cooling caused by a fan used to cool a general electronic device has been described for the cooling unit according to the first to third embodiments. However, the example is not limited thereto, and a cooling method using a radiator or a compressor type, server cooler or water cooling type, oil cooling type, or peltier element may be adopted. Furthermore, combination of the heat pipe and the cooling fan, or combination with the cooling method may be adopted.

In the illustrated case, the cooling strength information saved in the cooling strength information table is stored with information representing the strength of cooling the electronic device by the respective method instead of the number of rotations of the fan.

The method disclosed in the example can be applied by using the cooling method with other than the cooling fan even if the cooling fan cools the electronic device or the electronic component more efficiently than other than the cooling fan. The computer apparatus thus can perform an appropriate cooling. Furthermore, if a cooling method with less noise than that of the cooling fan is adopted, the computer apparatus can further reduce the noise.

(2) Specific Heat Table

In the case of the first and the third embodiments, the rising temperature prediction unit calculates the rising temperature until a constant time has elapsed of each electronic component using the specific heat table unit. However, the example is not limited thereto, and a different method may be used.

For instance, when directly determining the strength to cool using the value of the power to be consumed by each electronic component until a constant time has elapsed, the computer apparatus does not require a specific heat table, and the cooling strength and the predicted power value are to be stored in the cooling strength information table unit corresponding to each other.

(3) Use of Nonlinear Curve by Prediction Calculation

The power prediction unit according to the first to third embodiments predicts the power value to be consumed until a constant time has elapsed after interpolating the most recent three power values with the B-spline curve for every prediction of the power values stored in the power measurement value accumulation unit. The example is not limited thereto, however, and the most recent three or more power values may be interpolated with the B-spline, or a different method may be used.

For instance, the power prediction unit may perform the prediction using the first derivation of the newest power value and the second newest power value without interpolating the power values with the B-spline curve. Furthermore, the calculation by the power prediction unit may be other than the first derivation of the newest power value and the second newest power value. For instance, the power prediction unit may take into consideration the (n−1) derivation value of the newest power value and the n^{th} newest power value.

The power prediction unit may interpolate the power values using other than the B-spline curve. For instance, the power prediction unit may interpolate the power values using the Bezier curve. Furthermore, the number of power values used for the interpolation is not limited to three and may be five points or more. The power prediction unit may not only perform the interpolation by the nonlinear curve, and may obtain a normal distribution function corresponding to the power values and perform the interpolation based on such function.

The computer apparatus can perform an appropriate cooling if the power to be consumed by the electronic apparatus, or the like until a constant time has elapsed can be accurately predicted using such illustrated methods.

(4) Correction of Cooling Strength

In the first embodiment, the cooling strength corresponding to the predicted temperature of each electronic component has been adopted. However, the example is not limited thereto, and correction that takes into consideration the temperature of the adjacent electronic components may be performed.

For instance, if the processor and the memory present at adjacent arrangements, the predicted rising temperature of the memory is low, and the predicted rising temperature of the processor is high, the temperature of the memory reaches a temperature higher than predicted by the heat emitted by the processor. In such a case, the cooling control unit may cool the memory in advance at the cooling strength that takes into consideration the heat emitted by the processor.

The computer apparatus can perform a more appropriate cooing by taking into consideration the rising temperature of the adjacent electronic components.

(5) Application to Other than Computer Apparatus

The cooling determination section according to the first to third embodiments cools the computer apparatus. However, the example is not limited thereto, and the processes described above may be performed to cool another device. For instance, the cooling determination section according to the example may perform a cooling process of a large volume storage device such as a storage or a file server, a cooling process of a blade server, or a cooling process of other electronic products.

(6) Correspondence of Measuring Target and Cooling Target

The cooling determination section according to the first to third embodiments measures the power consumed by the computer apparatus or the component of the computer apparatus, and cools the computer apparatus or the component of the computer apparatus. However, the target to be measured and cooled in the example is not limited only to such relationship.

For instance, if a cooling unit for cooing a plurality of computer apparatuses presents as in the blade server, the power consumed by each computer apparatus (blade) is measured to cool the entire blade server or every blade.

The target the cooling determination section according to the present example measures the power value is not limited to those illustrated in the first to third embodiments. For instance, the cooling determination section may measure the power consumed by the graphic board or other electronic components.

(7) Program

In the cooling determination section according to the first to third embodiments, a case of realizing various types of processes using hardware has been described, but the present invention is not limited thereto and the various types of processes may be realized by executing the program prepared in advance on a computer.

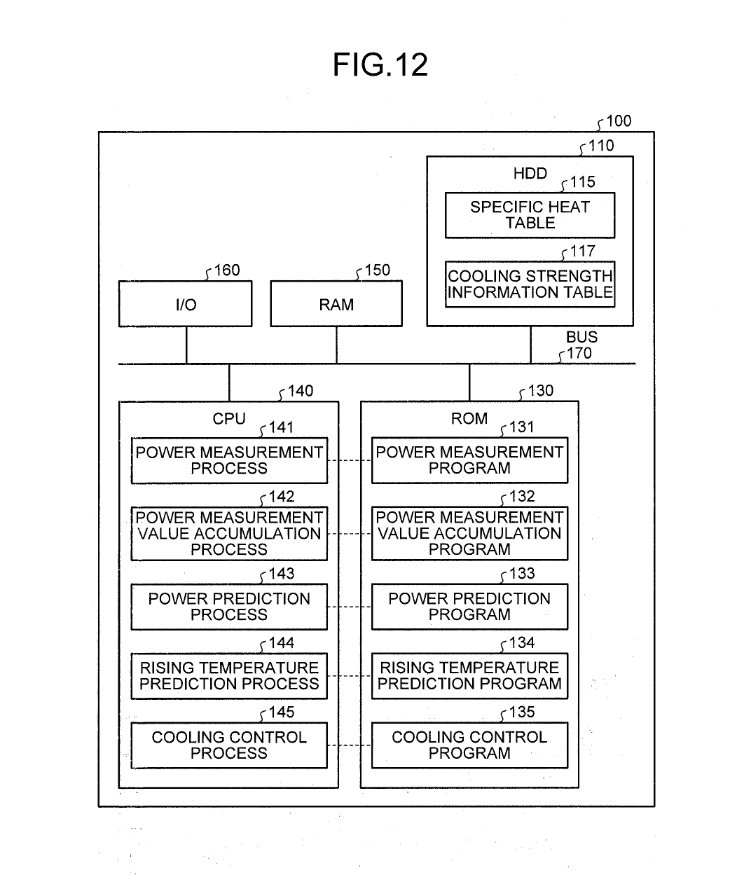

In the following description, one example of a computer for executing the program having the function similar to the cooling determination section shown in the first embodiment will be described with reference to FIG. 12. The present example may have functions similar to the cooling determination section shown in the second and third embodiments other than the cooling determination section shown in the first embodiment.

A computer 100 illustrated in FIG. 12 has a Hard Disk Drive (HDD) 110, a Random Access Memory (RAM) 150, a Central Processing Unit (CPU) 140, and a Read Only Memory (ROM) 130 connected with a bus 170. A connection termination portion Input/Output (I/O) 160 for connecting with the computer section 50 and the cooling units 41 to 43 is also connected to the bus 170.

The HDD 110 saves a specific heat table 115 and a cooling strength information table 117. The HDD 110 does not need to be incorporated in the computer 100, and the specific heat table 115 and the cooling strength information table 117 may be saved in a distributed manner using a network storage in an external memory, or a plurality of HDDs. The specific heat table 115 and the cooling strength information table 117 may also be saved in the computer section including the cooling target.

The ROM 130 saves in advance a power measurement program 131, a power measurement value accumulation program 132, a power prediction program 133, a rising temperature prediction program 134, and a cooling control program 135. The CPU 140 reads each program 131 to 135 from the ROM 130 and executes the same, so that each program 131 to 135 functions as a power measurement process 141, a power measurement value accumulation process 142, a power prediction process 143, a rising temperature prediction process 144, and a cooling control process 145, as illustrated in FIG. 12.

Each process 141 to 145 corresponds to the power measurement unit 31, the power measurement value accumulation unit 32, the power prediction unit 33, the rising temperature prediction unit 34, and the cooling control unit 36 illustrated in FIG. 1.

Each program 141 to 145 does not need to be held in the ROM 130, and may be stored in the HDD 110 and developed by the CPU 140 to function as each process 141 to 145.

The CPU 140 may be a Micro Controller Unit (MCU) or a Micro Processing Unit (MPU).

The cooling method described in the present example may be realized by executing the program prepared in advance with a computer such as a personal computer or a work station. Such program can be distributed through the network such as Internet. The program may also be stored in a computer readable storage medium such as a hard disc, a flexible disc (FD), a CD-ROM, an MO, or a DVD and executed by being read from the storage medium by the computer.

According to one aspect of the electronic apparatus disclosed in the present application, it is possible to appropriately cool the cooling target.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it may be understood that the various changes, substitutions, and alterations could be made hereto without departing from the spirit and scope of the invention.

What is claimed is:

1. An electronic apparatus comprising:
a power measurement unit that measures a consumed power value, which is a value of power consumed by a cooling target;
a power measurement value storage unit that stores a history of the consumed power value measured by the power measurement unit;
a power prediction unit that predicts a power value to be consumed by the cooling target using the history of the consumed power value stored by the power measurement value storage unit; and
a cooling control unit that controls a cooling unit so as to change a cooling strength on the cooling target according to the power value predicted by the power prediction unit.

2. The electronic apparatus according to claim 1, further comprising:
a temperature prediction unit that predicts a temperature of the cooling target based on the consumed power value predicted by the power prediction unit,
wherein the cooling control unit controls the cooling unit according to the predicted temperature of the cooling target predicted by the temperature prediction unit.

3. The electronic apparatus according to claim 1, further comprising:
a specific heat storage unit that stores a specific heat indicating a power amount to raise the cooling target by an arbitrary temperature; and
a rising temperature prediction unit that calculates a power amount to be consumed by the cooling target using the power value predicted by the power prediction unit, and divides the power amount by a specific heat of the cooling target stored in the specific heat storage unit to predict a rising temperature of the cooling target until a constant time has elapsed,
wherein the cooling control unit controls the cooling unit so as to change the cooling strength on the cooling target according to the rising temperature predicted by the rising temperature prediction unit.

4. The electronic apparatus according to claim 3, wherein
the specific heat storage unit stores a specific heat for a plurality of cooling targets;
the power measurement unit measures the consumed power value of each cooling target;
the power measurement value storage unit stores the consumed power value of each cooling target measured by the power measurement unit;
the power prediction unit predicts the power value to be consumed by each cooling target using the history of the consumed power value for each cooling target stored by the power measurement value storage unit; and
the rising temperature prediction unit calculates the power amount to be consumed by each cooling target for the power value of each cooling target predicted by the power prediction unit, and divides the power amount of each cooling device with the specific heat of each cooling target stored in the specific heat storage unit to predict a rising temperature of each cooling target.

5. The electronic apparatus according to claim 4,
wherein the cooling control unit controls the cooling unit so as to change the cooling strength according to a distribution of temperatures of the entire apparatus presumed from the rising temperature of each cooling target predicted by the rising temperature prediction unit.

6. The electronic apparatus according to claim 1, further comprising:
a cooling strength information storage unit that stores cooling strength information indicating a cooling strength on the cooling target and the rising temperature of the cooling target corresponding to each other,
wherein the cooling control unit acquires the cooling strength information corresponding to the rising temperature of the cooling target predicted by the rising temperature prediction unit from the cooling strength information storage unit, and controls the cooling unit so as to change the cooling strength on the cooling target based on the acquired cooling strength information.

7. The electronic apparatus according to claim 1,
wherein the power measurement value storage unit uses three or more points of most recent power values stored by the power value accumulation unit to derive a nonlinear curve indicating change in power value, predicts a power value between two points of the most recent power values from the nonlinear curve, and predicts a power value to be consumed by the cooling target based on the predicted power value and the most recent power value.

8. The electronic apparatus according to claim 1,
wherein the power measurement value storage unit uses a most recent power value of three or more points stored by a power value accumulation unit to predict the approximate power value, and controls the cooling unit based on the predicted approximate power value.

9. A non-transitory computer-readable storage medium storing therein a cooling program, the cooling program causing a computer to execute a procedure comprising:
measuring a consumed power value, which is a value of power consumed by a cooling target;
predicting a power value to be consumed by the cooling target using a history of the consumed power value measured at the measuring; and
controlling a cooling unit that cools the cooling target so as to change a cooling strength on the cooling target according to the power value predicted at the predicting before the constant time has elapsed.

10. The non-transitory computer-readable storage medium according to claim 9, the cooling program causing the computer to execute the procedure further comprising:
calculating a power amount to be consumed by the cooling target using the power value predicted at the predicting;
acquiring a specific heat from a specific heat storage unit that stores a specific heat indicating a relationship of a rising temperature of the cooling target and a power amount to raise the temperature; and
dividing the power amount by the acquired specific heat to predict a rising temperature or a temperature to which the cooling target rises, wherein
the controlling includes controlling the cooling unit so as to change the cooling strength on the cooling target according to the rising temperature predicted at the calculating.

11. The non-transitory computer-readable storage medium according to claim 10, wherein
the measuring includes measuring the consumed power value of each cooling target;
the predicting includes predicting the power value to be consumed by each cooling target using a history of the consumed power value of each cooling target measured at the measuring;
the acquiring includes acquiring a specific heat of each cooling target from the specific heat storage unit that stores a specific heat indicating the power amount for the temperature of each cooling target to rise;
the calculating includes calculating the power value to be consumed by the cooling target for the power value of each cooling device predicted at the predicting with respect to a plurality of cooling targets;
the dividing includes dividing the power value of each cooling target by the acquired specific heat of each cooling target to predict a rising temperature or a temperature to which each cooling target rises; and
the controlling includes controlling the cooling unit so as to change the cooling strength on the entire cooling target according to a distribution of temperatures of the entire apparatus presumed from the rising temperature of each cooling target predicted.

12. The non-transitory computer-readable storage medium according to claim 9, wherein
the controlling includes acquiring from a cooling strength information storage unit, which stores cooling strength information or information related to a cooling strength on the cooling target and the rising temperature of the cooling target corresponding to each other, the cooling strength information corresponded to the rising temperature predicted at the predicting, and controlling the cooling unit so as to change the cooling strength on the cooling target based on the cooling strength information.

13. The non-transitory computer-readable storage medium according to claim 9, wherein,
the predicting includes deriving a nonlinear curve from three points of most recent power values measured at the measuring, predicting a power value between two points of the most recent power values from the nonlinear curve, and predicting a power value to be consumed by the cooling target from a difference between the predicted power value and the most recent power value.

14. An electronic apparatus comprising:
a processor; and
a memory, wherein the processor executes:
measuring a consumed power value, which is a value of power consumed by a cooling target;
predicting a power value to be consumed by the cooling target using a history of the consumed power value measured at the measuring; and
controlling a cooling unit that cools the cooling target so as to change a cooling strength on the cooling target according to the power value predicted at the predicting.
